(19) United States
(12) Patent Application Publication
(10) Pub. No.: US 2025/0286428 A1
(43) Pub. Date: Sep. 11, 2025

(54) BEARING DEVICE WITH INTEGRATED ELECTRICAL INSULATION, NOTABLY FOR AN ELECTRIC MOTOR OR MACHINE

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR); Anthony SIMONIN, Tours (FR)

(21) Appl. No.: 19/068,569

(22) Filed: Mar. 3, 2025

(30) Foreign Application Priority Data
Mar. 11, 2024 (FR) 2402410

(51) Int. Cl. H02K 5/173; F16C 41/00

(52) U.S. Cl. CPC H02K 5/173; F16C 41/002; F16C 2220/02

(57) ABSTRACT

A bearing device includes a bearing having first and second rings, a bushing and an electrically insulating insert overmolded between and connecting the bushing and a cylindrical surface of the second ring. The bushing is formed from two parts each having a cylindrical portion and a radial collar, and the insert is overmolded onto the cylindrical portions and the collars. Also, a surface of the first cylindrical portion and a surface of the second cylindrical portion together delimit a radially inner surface of the bushing or a radially outer surface of the bushing.

### CROSS-REFERENCE

This application claims priority to French patent application no. 2402410 filed on Mar. 11, 2024, the contents of which are fully incorporated herein by reference.

### TECHNOLOGICAL FIELD

The present disclosure relates to the field of bearings that are particularly used in electric motors, electric machines and associated equipment.

### BACKGROUND

In an electric motor or machine, at least one rolling bearing is mounted between the housing of the electric motor or machine and the rotary shaft in order to support this shaft. During operation, when the shaft is rotating, a difference in electric potential can occur between the shaft and the housing of the motor or of the electric machine, generating an electric current between the inner ring of the rolling bearing, which is rigidly connected to the shaft, and the outer ring, which is rigidly connected to the housing. The electric current flowing through the components of the rolling bearing can damage these components, notably the rolling elements and raceways provided on the inner and outer rings. Electrical discharges can also generate vibrations.

In order to overcome these disadvantages, a known solution involves replacing the rolling elements of the bearing, which are made from the same steel as the inner and outer rings, with rolling elements made of ceramic. This is generally referred to as a hybrid rolling bearing. However, such a hybrid rolling bearing is relatively expensive.

In order to overcome the aforementioned disadvantages, another known solution involves equipping the outer ring of the rolling bearing with an insulating sleeve provided with a bushing and an insulating insert made of electrically insulating material and radially interposed between the outer ring and the bushing. In order to attach the insulating insert to the outer ring and to the bushing without any additional elements or specific machining on the outer ring, the insulating insert can be overmolded. However, with such a solution, relative uncoupling of the insulating insert and of the bushing can sometimes occur during operation.

### SUMMARY

Therefore, an aspect of the present disclosure is to overcome the aforementioned disadvantages by providing a bearing device with a simple and economical design. Another aspect of the disclosure is a bearing device comprising a bearing having a first ring and a second ring that are able to rotate relative to one another.

The device further comprises at least one insulating sleeve mounted on the second ring of the bearing. The insulating sleeve is provided with a bushing and an insulating insert radially interposed between the second ring of the bearing and the bushing. The insulating insert is made of an electrically insulating material.

The bushing has an outer surface and an inner surface, opposite the outer surface, which delimit the radial thickness of the bushing. The insulating insert is overmolded onto the second ring of the bearing and at least onto one of the outer and inner surfaces of the bushing.

According to a general feature, the bushing is produced in at least two distinct parts, each part comprising an axial portion and a radial collar extending radially from the axial portion. According to another general feature, the axial portions of the two parts at least partly jointly delimit the surface of the bushing onto which the insulating insert is overmolded. According to yet another general feature, the insulating insert is also overmolded onto an inner face of the radial collar of each of the two parts of the bushing.

Producing the two parts of the bushing with radial collars allows a good connection to be obtained with the insulating insert. The risk of any relative movements between the insulating insert and the bushing in the axial direction is avoided, notably during temperature variations.

As used herein, “axial direction” is understood to mean the direction parallel to the axis of the bearing device.

Furthermore, compared with a one-piece construction of the bushing equipped with collars, producing the bushing in at least two distinct parts facilitates the installation of the second ring inside the mold provided for overmolding the insulating insert.

This provides a bearing device with integrated electrical insulation that is economical compared with conventional hybrid rolling bearings and is easy to manufacture.

Preferably, the radial collar of at least one of the two parts of the bushing radially extends beyond an outer or inner surface of the second ring onto which the insulating insert is overmolded.

With such an arrangement, the part of the insulating insert that is axially located between the second ring and this radial collar of the bushing does not experience shearing stresses when high axial loads are applied to the device mounted inside the housing of the associated electric motor or machine with this collar in abutment against a shoulder of the housing. Indeed, in this case, compression stresses are applied to this part of the insulating insert. This increases the reliability of the device.

Advantageously, the radial collar of each of the two parts of the bushing radially extends beyond the outer or inner surface of the second ring onto which the insulating insert is overmolded. As a variant, it is nevertheless possible for at least one of the two radial collars or both collars to be flush with the outer or inner surface of the second ring or to remain radially set back. In one embodiment, the two parts of the bushing are symmetrical relative to a radial midplane of the device. This reduces the manufacturing cost of the device.

According to a particular design, the axial portions of the two parts of the bushing are axially in contact against each other and jointly delimit the whole of the surface of the bushing onto which the insulating insert is overmolded.

According to another design, the axial portions of the two parts of the bushing are axially spaced apart from each other. In this case, the bushing can further comprise an additional ring axially interposed between the axial portions of the two parts and jointly delimiting, with the axial portions of the two parts of the bushing, the surface of the bushing onto which the insulating insert is overmolded.

According to a particular design, the surface of the bushing is provided with at least one groove extending in the circumferential direction and inside which a rib of matching shape extends for attaching the insulating insert. This further increases the axial attachment of the insulating insert on the bushing.

As used herein, “circumferential direction” is understood to mean the direction that is perpendicular both to the axial direction and to a radius of the bearing device, in other words, tangent to a circle whose center is on the axis of the bearing device.

Each axial portion of the two parts of the bushing can be provided with at least one groove extending in the circumferential direction and inside which a rib of matching shape extends for attaching the insulating insert.

The bushing can be provided with two front faces delimiting its axial length.

According to a first design, the radial collar of at least one of the two parts is axially flush with one of the front faces of the bushing.

According to a second design, the radial collar of each of the two parts of the bushing is axially flush with one of the front faces of the bushing.

Alternatively, one or each of the radial collars can be axially inwardly or outwardly offset relative to the associated front surface of the bushing.

If the insulating insert is made of synthetic or elastomer material, it makes the device insensitive to temperature variations.

In a particular embodiment, the bushing is made of metal material. The bushing thus can be easily machined to a predetermined radial tolerance.

In one embodiment, the insulating insert covers the whole of the surface of the bushing. In this case, the insulating insert completely covers the surface of the bushing in the axial direction and in the circumferential direction.

According to a first design, the bushing delimits the outer surface of the device. In this case, the second ring is the outer ring of the bearing. According to a second alternative design, the bushing delimits the inner surface of the device. In this case, the second ring is the inner ring of the bearing.

According to an embodiment, a bearing device comprises a bearing including a first ring and a second ring configured to rotate relative to each other about a central axis, the second ring having a first cylindrical surface and a second cylindrical surface radially spaced from the first cylindrical surface. The device also include a bushing and an electrically insulating insert overmolded between and connecting the bushing and the second cylindrical surface of the second ring. The bushing comprises a first part having an axially extending first cylindrical portion and a first annular collar extending radially from a first axial end of the first cylindrical portion and a second part having an axially extending second cylindrical portion and a second annular collar extending radially from a first axial end of the second cylindrical portion. A first surface of the first cylindrical portion faces the second ring and a first surface of the second cylindrical portion faces the second ring and a first surface of the first collar faces a first surface of the second collar. The electrically insulating insert is overmolded onto the first surface of the first cylindrical portion and onto the first surface of the second cylindrical portion and onto the first surface of the first collar and onto the first surface of the second collar. Also a second surface of the first cylindrical portion is radially spaced from the first surface of the first cylindrical portion and a second surface of the second cylindrical portion is radially spaced from the first surface of the second cylindrical portion, and the second surface of the first cylindrical portion and the second surface of the second cylindrical portion together delimit a radially inner surface of the bushing or a radially outer surface of the bushing.

In a particular embodiment, the bearing comprises at least one row of rolling elements disposed between raceways of the first and second rings. The rolling elements can be made of metal material.

The disclosure also relates to an electric motor comprising a housing, a shaft and at least one bearing device as defined above and radially mounted between the housing and the shaft.

The disclosure also relates to a method for manufacturing a bearing device as defined above, that includes a step of mounting one of the parts of the bushing in the bottom of a manufacturing mold, a step of installing the second ring inside the manufacturing mold, a step of mounting the other one of the parts of the bushing inside the manufacturing mold, a step of overmolding the insulating insert onto the second ring and at least onto the surface of the bushing, and a step of assembling, with the first ring of the bearing, the assembly formed by the second ring, the parts of the bushing and the insulating insert.

### BRIEF DESCRIPTION OF THE DRAWINGS

The present invention will be better understood with reference to the detailed description of an embodiment, which is provided by way of a non-limiting example and is illustrated by the appended drawings, in which:

FIG. 1 is a half-view of an axial section of a bearing device according to one embodiment of the disclosure.

FIG. 2 is a partial exploded perspective view of the bearing device of FIG. 1 with the insulating insert removed for illustration purposes.

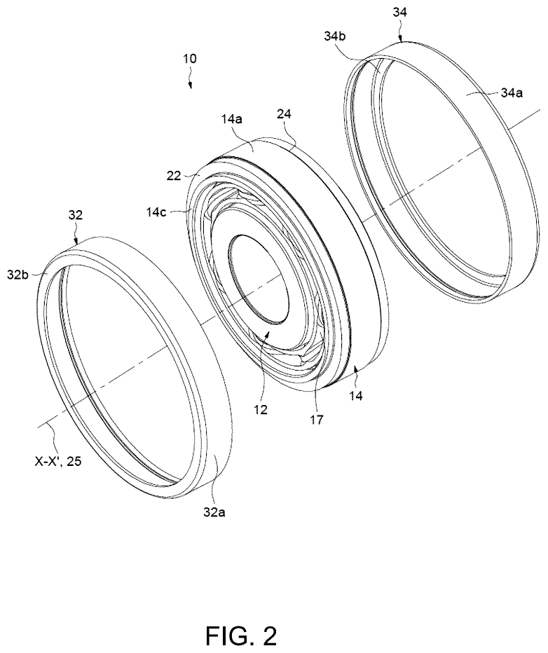

FIG. 3 is a half-view of an axial section of one of the parts of a bushing of the bearing device of FIG. 1.

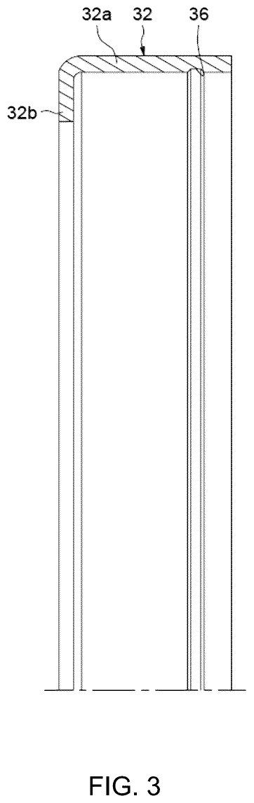

FIG. 4 is a flowchart illustrating the method for manufacturing the bearing device of FIG. 1.

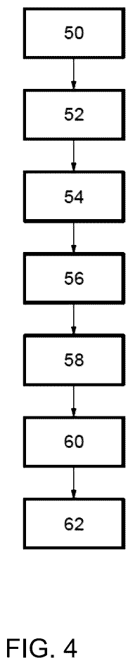

### DETAILED DESCRIPTION

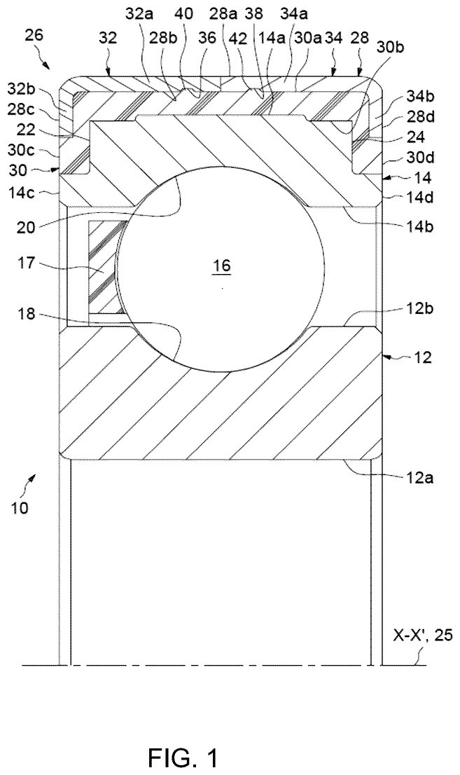

The bearing device illustrated in FIG. 1 comprises a bearing 10 provided with a first ring 12 and a second ring 14 that are configured to rotate relative to each other about the X-X′ axis of the bearing. In the illustrated embodiment, the first ring 12 is the inner ring of the bearing and the second ring 14 is the outer ring.

As will be described in further detail hereafter, the bearing device is designed so that it does not conduct electric currents. The bearing device has integrated electric insulation.

The inner 12 and outer 14 rings of the bearing are concentric and extend axially along the X-X′ axis of the bearing. The inner 12 and outer 14 rings are made of steel. The rings are solid type rings.

In the illustrated embodiment, the bearing 10 also comprises a row of rolling elements 16, in this case balls, radially interposed between the inner 12 and outer 14 rings. The rolling elements 16 are made of steel. The bearing 10 also comprises a cage 17 for maintaining the even circumferential spacing of the rolling elements 16. The bearing 10 also can be equipped with sealing seals or flanges.

The inner ring 12 comprises a cylindrical bore 12a, a cylindrical axial outer surface 12b radially opposite the bore, and two opposite radial front faces (not referenced) axially delimiting the bore and the outer surface. The bore 12a and the outer surface 12b delimit the radial thickness of the inner ring 12. The bore 12a forms the inner surface of the inner ring. The inner ring 12 also comprises an inner raceway 18 for the rolling elements 16 that is formed on the outer surface 12b. The raceway 18 is directed radially outwards.

The outer ring 14 comprises a cylindrical axial outer surface 14a, a cylindrical bore 14b radially opposite the outer surface 14a, and two opposite radial front faces 14c, 14d axially delimiting the bore. The outer surface 14a and the bore 14b delimit the radial thickness of the outer ring 14. In the illustrated embodiment, the outer surface 14a of the ring has portions having two distinct diameters. Alternatively, the outer surface 14a could have a single diameter. The outer ring 14 further comprises an outer raceway 20 for the rolling elements 16, which is formed on the bore 14b. The raceway 20 is directed radially inwards.

In the illustrated embodiment, a groove 22 is provided on the front face 14c of the outer ring. In other words, a diameter of the outer ring at the front face 14c is smaller than a diameter of the outer ring at a distance from the front face 14c. The groove 22 is axially oriented towards the outside of the outer ring. The groove 22 has a bottom that is axially offset towards the inside of the ring relative to the front face 14c. The bottom of the groove 22 forms a shoulder. The bottom of the groove 22 in this case extends radially for ease of manufacturing. The groove 22 is annular in this case.

Similarly, a groove 24 is provided on the front face 14d of the outer ring. In other words, a diameter of the outer ring at the front face 14d is smaller than a diameter of the outer ring at a distance from the front face 14d. The groove 24 is axially oriented towards the outside of the outer ring. The groove 24 has a bottom that is axially offset towards the inside of the ring relative to the front face 14d. The bottom of the groove 24 forms a shoulder. The bottom of the groove 24 extends radially in this case. The groove 24 is annular in this case. The grooves 22, 24 are symmetrical with each other relative to a radial midplane of the outer ring. The grooves 22, 24 axially delimit the outer surface 14a.

The bearing device also comprises an electrically insulating sleeve 26 mounted on the outer ring 14. The insulating sleeve 26 is mounted on the outer surface 14a of the outer ring 14. The insulating sleeve 26 is rigidly connected to the outer ring 14. The insulating sleeve 26 comprises a bushing 28 and an insulating insert 30 radially interposed between the outer ring 14 and the bushing 28. The insulating insert 30 is overmolded onto the outer ring 14 and the bushing 28.

The bushing 28 is annular. The bushing 28 is made up of two distinct parts: a first part 32 and a second part 34. These two separate parts 32, 34 form half-flanges that in this case are axially in abutment against each other. In the illustrated embodiment, the parts 32, 34 of the bushing are identical and symmetrical relative to a radial midplane of the device in order to reduce the manufacturing costs. Alternatively, it is of course possible for non-symmetrical parts 32, 34 to be provided. In another variant, it is possible for the bushing 28 to be made up of more than two parts. Preferably, the parts 32, 34 of the bushing 28 are made of steel. The parts 32, 34 advantageously can be obtained from a metal sheet by cutting, stamping and rolling. Alternatively, the parts 32, 34 can be obtained from a tube or from forged/rolled blanks, or even from sintering and stamping.

The first part 32 of the bushing includes an axially extending first cylindrical portion 32a and a first annular collar 32b extending radially inward from an axial end of the first cylindrical portion. The second part 34 of the bushing includes an axially extending second cylindrical portion 34a and a second annular collar 34b extending radially inward from an axial end of the second cylindrical portion. The axially extending portions 32a, 34a are axially in abutment against each other. The annular collars 32b, 34b extend inward from axially opposite ends of the axially extending portion 32a, 34a axially located on the outside of the device. In the illustrated embodiment, the collars 32b, 34b are annular. Alternatively, at least one of the collars 32b, 34b could be in the form of sectors spaced apart from each other in the circumferential direction.

The bushing 28 comprises a cylindrical axial outer surface 28a, and a cylindrical bore 28b radially opposite the outer surface 28a, the axis 25 of which is coaxial with the X-X′ axis. The bore 28b forms the inner surface of the bushing 28. The axial portions 32a, 34a of the parts of the bushing jointly delimit the outer surface 28a. Similarly, the axial portions 32a, 34a of the parts jointly delimit the bore 28b. The outer surface 28a and the bore 28b delimit the radial thickness of the bushing 28. The outer surface 28a of the bushing forms the outer surface of the bearing device 10. In other words, the outer surface 28a defines the outer diameter of the bearing device 10.

The bushing 28 also comprises two opposite radial front faces 28c, 28d axially delimiting the outer surface 28a. The front faces 28c, 28d delimit the axial length of the bushing. The front face 28c is delimited by the radial collar 32b, and the front face 28d is delimited by the radial collar 34b. More specifically, the front face 28c is delimited by the outer face of the radial collar 32b, and the front face 28d is delimited by the outer face of the radial collar 34b.

In the illustrated embodiment, the front faces 28c, 28d of the bushing are respectively coplanar with the front faces 14c, 14d of the outer ring. Alternatively, other arrangements can be provided. For example, the bushing 28 could have a smaller or greater axial dimension and could remain axially set back from the faces 14c, 14d of the outer ring, or could project from the faces.

In the illustrated embodiment, the radial collars 32b, 34b of the parts of the bushing radially extend beyond the outer surface 14a of the outer ring, i.e., radially project inwards relative to the outer surface 14a. In other words, the free ends of the radial collars 32b, 34b are radially offset inwards relative to the outer surface 14a of the outer ring. The radial collars 32b, 34b partly extend into the grooves 22, 24 of the outer ring. The radial collars 32b, 34b remain at a distance from the inner ring 12.

The bore of the axial portion 32a, 34a of each part 32, 34 of the bushing is provided with a groove 36, 38 that circumferentially extends around the axis 25 of the bore of the bushing. Each groove 36, 38 is radially oriented towards the outer ring 14, i.e., radially inwards.

In the illustrated embodiment, each groove 36, 38 is annular. Alternatively, at least one of the two grooves 36, 38 may not extend over 360°, or even may be formed by a succession of circumferentially extending turns that are spaced apart from one another in the circumferential direction.

Each groove 36, 38 is delimited in the axial direction by two opposing lateral flanks that have a straight profile as an axial section and are connected together by an axial bottom. Alternatively, other shapes can be provided, for example, grooves that in this case, as a cross section, assume the shape of an inwardly oriented arc of a circle. In another variant, the bushing 28 also can be devoid of grooves 36, 38.

The insulating insert 30 is made of electrically insulating material. The insulating insert 30 can be made, for example, of synthetic material, such as PEEK or PA46, or it even can be made of elastomer material, such as rubber, for example.

The insulating insert 30 is radially interposed between the outer surface 14a of the outer ring and the bore 28b of the bushing. The insulating insert 30 covers the outer surface 14a of the outer ring. In this case, the insulating insert 30 completely covers the outer surface 14a in the axial and circumferential directions. The insulating insert 30 also covers the grooves 22, 24 of the outer ring

The insulating insert 30 also covers the bore 28b of the bushing. The insulating insert 30 in this case also completely covers the bore 28b in the axial and circumferential directions. The insulating insert 30 covers the bore of the axial portion 32a, 34a of each part 32, 34 of the bushing.

The insulating insert 30 also covers the inner face of the radial collar 32b, 34b of each part 32, 34 of the bushing. The inner face and the outer face axially opposite the inner face of each radial collar 32b and 34b delimit the axial thickness of the collar. For each radial collar 32b and 34b, the inner face is axially oriented towards the inside of the device, and the outer face is axially oriented towards the outside of the device. The insulating insert 30 also covers the free end of the radial collar 32b, 34b of each part 32, 34 of the bushing.

The insulating insert 30 is annular. The insulating insert 30 extends axially. The insulating insert 30 comprises a cylindrical axial outer surface 30a, a cylindrical bore 30b radially opposite the outer surface 30a, and two opposite radial front faces 30c, 30d axially delimiting the bore and the outer surface. The radial front faces 30c, 30d axially delimit the insulating insert 30. The outer surface 30a and the bore 30b delimit the radial thickness of the insulating insert 30. The outer surface 30a is in radial contact with the bore 28b of the bushing. The outer surface 30a is also in radial contact with the free end of the radial collar 32b, 34b of each part 32, 34 of the bushing. The outer surface 30a assumes a stepped shape. The bore 30b is in radial contact with the outer surface 14a of the outer ring and with the grooves 22, 24. The bore 30b has a stepped shape.

In the illustrated embodiment, the faces 14c, 30c, 28c and 14d, 30d, 28d of the outer ring, the insulating insert and the bushing are respectively coplanar.

Alternatively, other arrangements can be provided. For example, the insulating insert 30 could have a limited axial dimension and could remain axially set back from the faces 14c, 14d of the outer ring. Alternatively, the insulating insert 30 could have a greater axial dimension and axially project from the faces 14c, 14d of the outer ring. In this case, the insulating insert 30 can at least partly cover these faces 14c, 14d. As a variant, the insulating insert 30 could at least partly cover the faces 28c, 28d of the bushing.

In another alternative, or in combination, the bushing 28 could axially project from the insulating insert 30 relative to the faces 30c and 30d, or could remain axially set back from these faces.

The insulating insert 30 also comprises two ribs 40, 42 extending radially outwards from the outer surface 30a and each accommodated inside one of the grooves 36, 38 of the bushing. The rib 40, 42 assumes a shape that matches the associated groove 36, 38. Each rib 40, 42 projects from the outer surface 30a of the insulating insert. Each rib 40, 42 is formed on the outer surface 30a when overmolding the insulating insert 30.

The bearing device is manufactured as follows.

In a first step 50, the first part 32 of the bushing is mounted inside a mold, which is provided for overmolding the insulating insert 30.

In a second successive step 52, the outer ring 14 equipped with the grooves 22, 24 is installed inside the mold.

Then, in a third step 54, the second part 34 of the bushing is mounted inside the mold, axially in abutment against the first part 32. In this position mounted inside the mold, the first part 32 and the second part 34 of the bushing are radially at a distance from the outer ring 14.

Next, in a fourth successive step 56, the insulating insert 30 is overmolded both onto the outer ring 14 and onto the first and second parts 32, 34 of the bushing 28. The ribs 40, 42 in the insulating insert are formed during this step.

In a fifth successive step 58, the unitary assembly formed by the outer ring 14, the first and second parts 32, 34 of the bushing 28 and the insulating insert 30 is extracted from the mold.

Then, in a sixth successive step 60, the front faces 14c, 14d and the faces 28c, 28d of the bushing are ground. Given the presence of the collars 32b and 34b of the bushing, the grinding operation is mainly carried out on the bushing and the outer ring, and not on the insulating insert 30. During this step, the outer surface 28a of the bushing and the raceway 20 of the outer ring also can be ground.

Then, in a seventh step 62, the unitary assembly formed by the outer ring 14, the first and second parts 32, 34 of the bushing 28 and the insulating insert 30 is assembled with the row of rolling elements 16, the cage 17 and the inner ring 12.

In the illustrated embodiments, the first ring 12 of the bearing is the inner ring and the second ring 14, onto which the insulating insert 30 is overmolded, is the outer ring.

Alternatively, a reverse arrangement can be provided whereby the second ring 14, onto which the insulating insert 30 is overmolded, is the inner ring. In this case, the insulating sleeve is located in the bore 12a of the inner ring. The insulating insert is then radially interposed between the bore 12a of the inner ring and the outer surface of the bushing. The insulating insert is overmolded onto the inner ring and at least onto the outer surface of the bushing. The bore of the bushing delimits the bore of the bearing device.

In the described embodiments, the bearing of the device is provided with a single row of rolling elements. As a variant, the bearing can be provided with several rows of rolling elements. In addition, the rolling bearing can include types of rolling elements other than balls, for example, rollers. In another variant, the bearing can be a slider bearing devoid of rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the second ring having a first cylindrical surface and a second cylindrical surface radially spaced from the first cylindrical surface,
a bushing, and
an electrically insulating insert overmolded between and connecting the bushing and the second cylindrical surface of the second ring,
wherein the bushing comprises a first part having an axially extending first cylindrical portion and a first annular collar extending radially from a first axial end of the first cylindrical portion, and a second part having an axially extending second cylindrical portion and a second annular collar extending radially from a first axial end of the second cylindrical portion,
wherein a first surface of the first cylindrical portion faces the second ring and a first surface of the second cylindrical portion faces the second ring and wherein a first surface of the first collar faces a first surface of the second collar,
wherein the electrically insulating insert is overmolded onto the first surface of the first cylindrical portion and onto the first surface of the second cylindrical portion and onto the first surface of the first collar and onto the first surface of the second collar, and
wherein a second surface of the first cylindrical portion is radially spaced from the first surface of the first cylindrical portion and a second surface of the second cylindrical portion is radially spaced from the first surface of the second cylindrical portion, and
wherein the second surface of the first cylindrical portion and the second surface of the second cylindrical portion together delimit a radially inner surface of the bushing or a radially outer surface of the bushing.

2. The bearing device according to claim 1,
wherein a second axial end of the first cylindrical portion contacts a second axial end of the second cylindrical portion at a joint.

3. The bearing device according to claim 1,
wherein the bushing and the second ring are configured such that an imaginary cylinder centered on the central axis intersects the first annular collar and the second ring.

4. The bearing device according to claim 1,
wherein the bushing and the second ring are configured such that an imaginary cylinder centered on the central axis intersects the first annular collar and the second annular collar and the second ring.

5. The bearing device according to claim 1,
wherein the first part and the second part are symmetrical relative to a radial midplane of the second ring.

6. The bearing device according to claim 1,
wherein the bushing includes at least one radially facing groove, and
wherein a rib of the electrically insulating insert extends into the at least one radially facing groove.

7. The bearing device according to claim 1,
wherein the first surface of the first cylindrical portion includes at least one radially facing groove and the first portion of the second cylindrical portion includes at least one radially facing groove, and
wherein at least one first rib of the electrically insulating insert extends into the at least one radially facing groove of the first cylindrical portion and at least one second rib of the electrically insulating insert extends into the at least one radially facing groove of the second cylindrical portion.

8. The bearing device according to claim 1,
wherein a second surface of the first collar axially opposite the first surface of the first collar delimits a first axial end of the bushing and a second surface of the second collar axially opposite the first surface of the second collar axially delimits a second axial end of the bushing.

9. The bearing device according to claim 1,
wherein a second axial end of the first cylindrical portion contacts a second axial end of the second cylindrical portion at a joint,
wherein the bushing and the second ring are configured such that an imaginary cylinder centered on the central axis intersects the first annular collar and the second ring,
wherein the first part and the second part are symmetrical relative to a radial midplane of the second ring,
wherein the bushing includes at least one radially facing groove,
wherein a rib of the electrically insulating insert extends into the at least one radially facing groove, and
wherein a second surface of the first collar axially opposite the first surface of the first collar delimits a first axial end of the bushing and a second surface of the second collar axially opposite the first surface of the second collar axially delimits a second axial end of the bushing.

10. A method for manufacturing a bearing device according to claim 1 comprising:
a step of mounting one of the parts of the bushing in the bottom of a manufacturing mold;
a step of installing the second ring inside the manufacturing mold;
a step of mounting the other one of the parts of the bushing inside the manufacturing mold;
a step of overmolding the insulating insert onto the second ring and at least onto the surface of the bushing; and
a step of assembling, with the first ring of the bearing, the assembly formed by the second ring, the parts of the bushing and the insulating insert.

11. An electric motor comprising:
a housing,
a shaft, and
at least one bearing device according to claim 1 radially mounted between the housing and the shaft.

12. An electric motor comprising:
a housing,
a shaft, and
at least one bearing device according to claim 9 radially mounted between the housing and the shaft.
